(19) United States
(12) Patent Application Publication
(10) Pub. No.: US 2011/0106976 A1
(43) Pub. Date: May 5, 2011

(54) ELECTRONIC DEVICE FOR CONVEYING DEVICE INFORMATION

(76) Inventor: YEN-CHENG CHEN, Hsin Chu City (TW)

(21) Appl. No.: 12/938,103

(22) Filed: Nov. 2, 2010

(30) Foreign Application Priority Data
Nov. 4, 2009 (TW) 098137355

(51) Int. Cl. G06F 15/16

(52) U.S. Cl. 709/245

(57) ABSTRACT

An electronic device for conveying device information includes a body, an information processing module, a network communication module and a display module. The information processing module, disposed in the body, processes information. The network communication module, disposed in the body and coupled to the information processing module, is to be connected to a network. An IP address is assigned to the network communication module after the network communication module is connected to the network. The display module, disposed on the body and coupled to the information processing module, displays continuously an IP address message representative of the IP address.

This application claims priority of No. 098137355 filed in Taiwan R.O.C. on Nov. 4, 2009 under 35 USC 119, the entire content of which is hereby incorporated by reference.

### BACKGROUND OF THE INVENTION

1. Field of the Invention

The invention relates to an electronic device for conveying device information, and more particularly to an electronic device for conveying Internet protocol (IP) address information.

2. Related Art

A network printer, scanner or personal computer may be connected to the local area network (LAN) or Internet through a specific communication protocol, such as TCP/IP, so that the communication and data transmission can be performed.

Each printer or personal computer connected to the network has a unique Internet protocol (IP) address so that it can be distinguished from another and the data can be transmitted to the specific device. In order to use a network printer to print data, the users have to know the IP address of the printer. The users can check the status and information and change the settings of the printer through an application program or network browser. However, if the users want to know the IP address of the printer, they have to walk to the printer and do some associated complicated settings themselves. For example, the users have to operate the menu button to access the main menu of the printer, press the up and down buttons to select the IP address display option, and then press the “confirm” button to display the page containing the IP address information.

In the enterprise, to improve work efficiency and resource utilization, the printers are shared among a large number of employees through local networks. These network printers may include a black-and-white laser printer, a color laser printer, an ink-jet printer and a dot-matrix printer, and are often connected through a broadband router. The router can assign fixed IP addresses or floating IP addresses to these printers. However, the users cannot easily obtain either the fixed or floating IP address, except by the above-mentioned method.

For example, when the users in the office want to use the dot-matrix printer, they have to walk to the printer to check the IP address of the printer or ask someone who knows the information, and write down or memorize the IP address, and then set up their computers to access the printer. Consequently, the users have to spend longer time to print the document. For this reason, the users may cease using the printer (e.g., the color laser printer) suitable and appropriate for the document attributes, but, instead, continue to use the frequently used or default printer (e.g., the ink-jet printer), which, consequently, may cause negative impact on image quality or create waste of the consumable materials (e.g., the ink).

More particularly, when the users are in a public place (e.g., the library or the Internet bar), they may not get a printed document with the quality they hope for if they are not familiar with the local apparatuses, or when they do not know how to obtain the IP address of the printer.

### SUMMARY OF THE INVENTION

It is therefore an object of the invention to provide an electronic device which conveys device information in a visually evident manner, so that the users can obtain the IP address of the electronic device rapidly and conveniently.

To achieve the above-identified object, the invention provides an electronic device for conveying device information. The electronic device includes a body, an information processing module, a network communication module and a display module. The information processing module, disposed in the body, processes information. The network communication module is disposed in the body, coupled to the information processing module and connected to a network. An IP address is assigned to the network communication module after the network communication module is connected to the network. The display module, disposed on the body and coupled to the information processing module, displays continuously an IP address message representative of the IP address.

In addition, the invention further provides an electronic device for conveying device information. The electronic device includes a body, an information processing module, a network communication module, a display module and an IP-address-display-selecting module. The information processing module, disposed in the body, processes information. The network communication module is disposed in the body, coupled to the information processing module and connected to a network. An IP address is assigned to the network communication module after the network communication module is connected to the network. The display module is disposed on the body and coupled to the information processing module. The IP-address-display-selecting module, coupled to the information processing module, transmits a one-time IP address display signal to the information processing module, wherein the information processing module controls the display module to display an IP address message representative of the IP address for a predetermined period of time in response to the one-time IP address display signal.

Thus, the users can obtain the IP address of the electronic device rapidly and conveniently, so that various settings may be made from the remote computer.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing an electronic device according to a preferred embodiment of the invention.

FIG. 2 shows the implementation of projecting an IP address message according to the preferred embodiment of the invention.

FIG. 3 shows the implementation of broadcasting the IP address message according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

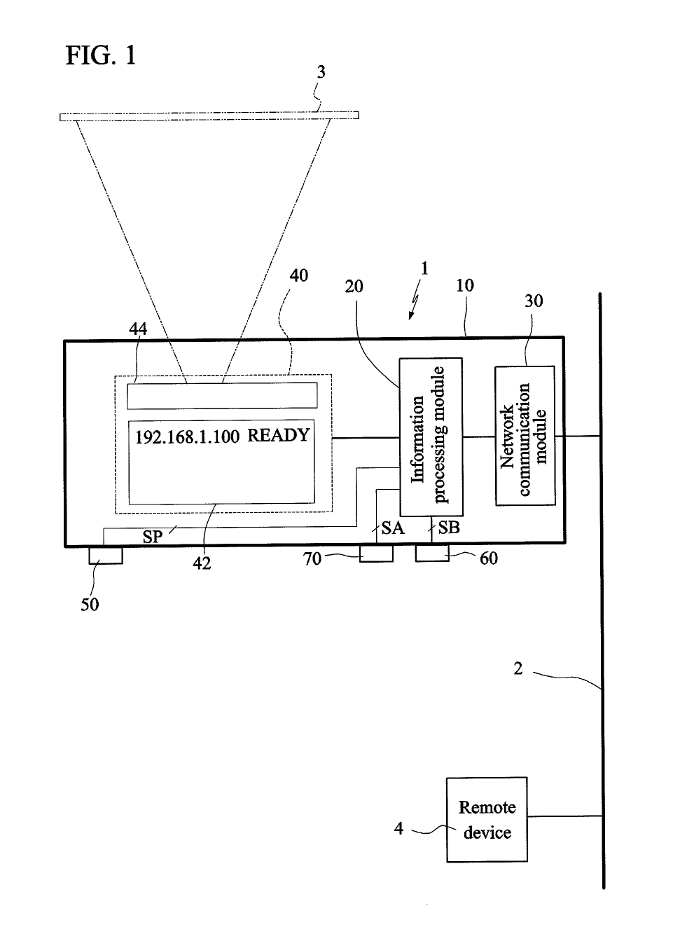

FIG. 1 is a schematic illustration showing an electronic device 1 according to a preferred embodiment of the invention. Referring to FIG. 1, the electronic device 1 includes a body 10, an information processing module 20, a network communication module 30 and a display module 40.

The electronic device 1 is, for example, a personal computer, a scanner, a printer, a multi-function peripheral, a server or a home product, which may be connected to the network. The information processing module 20, disposed in the body 10, is used for processing information like scanned or print data, and/or for controlling the electronic device.

The network communication module 30 is disposed in the body 10, coupled to the information processing module 20, and is connected to a network 2. An Internet protocol (IP) address, such as “192.168.1.100”, is assigned to the network communication module 30 after the network communication module 30 is connected to the network 2. The IP address may be a fixed IP address or a floating IP address. The network 2 may be the local area network (LAN) or Internet.

The display module 40, disposed in the body 10 and coupled to the information processing module 20, displays continuously the IP address which has been assigned to the network communication module 30. Alternatively, the display module 40 may display the IP address message and a status message of the information processing module 20 (e.g., the message (READY) representative of the inactive state) concurrently, so that the users could recognize whether the information processing module 20 is in an active state or the inactive state, or the users could monitor the job queue of the information processing module 20 to estimate the time length for the information processing module 20 to enter the inactive state. The display module may include a display screen, such as a liquid crystal display (LCD), an OLED display or a projecting screen.

In this embodiment, the display module 40 includes a screen 42, such as the LCD, for displaying continuously the IP address message. The user may view the IP address message from the screen 42.

In addition to the screen 42, the display module 40 may further include a projection module 44, such as a projector, for projecting the IP address message onto a projection medium 3, or onto the wall or ceiling, so that the IP address message may be displayed. Thus, everybody in the room can view the projected information. Alternatively, the projection module 44 may periodically (e.g., every 5 minutes) project the IP address message onto the projection medium 3.

The electronic device 1 may further include a projection selecting module 50, coupled to the information processing module 20, for outputting a projection signal SP. The information processing module 20 controls the projection module 44 to project the IP address message onto the projection medium 3 according to the projection signal SP. The user interface of the electronic device 1 may be configured to include an IP address projection option or button, so that the users can select to project the IP address message onto the wall or screen.

In another example, the electronic device 1 may further include a broadcast selecting module 60, coupled to the information processing module 20, for outputting a broadcast signal SB. The information processing module 20 controls the network communication module 30 to output the IP address message to a remote device 4 through the network 2 according to the broadcast signal SB. The remote device 4 may be, for example, a computer or any other electronic apparatus that is connected to the network. The remote device 4 receives the IP address message through the network and a specific application program. Similarly, the information processing module 20 may further control the network communication module 30 to output the status message of the information processing module 20 to the remote device 4 through the network 2 according to the broadcast signal SB. An IP address broadcasting option or button may be included as part of the user interface, so that the user can select to output the IP address message to the personal computer or other users' computers, and the users need not take notes of the IP address message by hand or by other means.

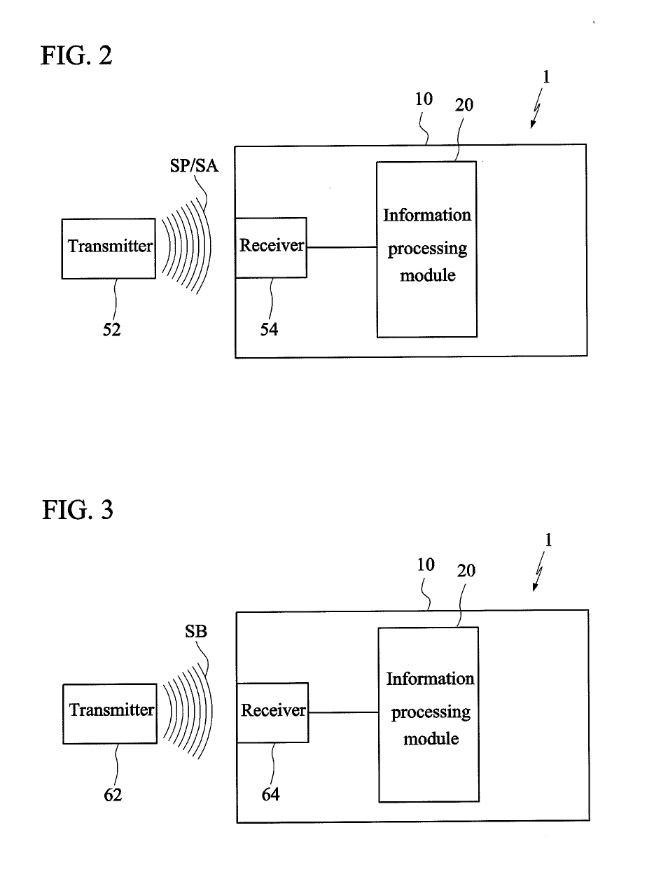

FIG. 2 shows the implementation of projecting an IP address message according to the preferred embodiment of the invention. Referring to FIG. 2, the electronic device 1 of the invention may further include a projection signal transmitter 52 for transmitting the projection signal SP and a projection signal receiver 54. The projection signal receiver 54, disposed in the body 10 and coupled to the information processing module 20, receives the projection signal SP. The information processing module 20 controls the projection module 44 to project the IP address message (and the status message) onto the projection medium 3 according to the projection signal SP. Therefore, the users can remotely control the electronic device 1 to display the IP address and the status message. The projection signal transmitter 52 is a remote control device for wirelessly controlling the electronic device 1 to project the IP address message onto the wall. With such device, the users can command the electronic device 1 to generate the IP address message without walking to the location where the electronic device 1 is placed. Every individual user may have a remote control device in possession to control the electronic device 1 at any time.

FIG. 3 shows the implementation of broadcasting the IP address message according to the preferred embodiment of the invention. Referring to FIG. 3, the electronic device 1 of the invention may further include a broadcast signal transmitter 62 for transmitting the broadcast signal SB and a broadcast signal receiver 64. The IP address broadcasting option or button is disposed in the same housing as the broadcast signal transmitter 62. The broadcast signal receiver 64, disposed in the body 10 and coupled to the information processing module 20, receives the broadcast signal SB. The information processing module 20 controls the network communication module 30 to output the IP address message (and the status message) to the remote device 4 through the network 2 according the broadcast signal SB. The user, thus, can remotely control the electronic device 1 to output the IP address and the status message of the electronic device 1 to a computer connected to the network.

In this embodiment, the IP address message is continuously displayed. In order to solve the conventional problem, a dedicated button or buttons may be disposed on the electronic device 1, so that the IP address and the status message may be displayed when the button or buttons are pressed. Referring again to FIG. 1, the electronic device 1 may further include an IP-address-display-selecting module 70. In this case, the display module 40 no longer displays continuously the IP address message representative of the IP address assigned. The IP-address-display-selecting module 70, coupled to the information processing module 20, transmits a one-time IP address display signal SA to the information processing module 20 when actuated. In response to the one-time IP address display signal SA, the information processing module 20 controls the display module 40 to display the IP address message representative of the IP address for a predetermined period of time, or to display the IP address message and the status message of the information processing module 20 concurrently for a predetermined period of time. In this example, the display module 40 includes the screen 42 for displaying the IP address message. Alternatively, the display module 40 may include the projection module 44 for projecting the IP address message onto the projection medium 3 and displaying the IP address message on the projection medium 3.

The IP-address-display-selecting module 70 may include an operation option or button disposed on the user interface of the body 10 of the electronic device 1. The electronic device 1 projects the IP address message onto the wall after the operation option or button is touched or pressed. Alternatively, the IP-address-display-selecting module 70 may include the projection signal transmitter 52 and the projection signal receiver 54 for transmitting and receiving the one-time IP address display signal SA, respectively. In this case, the operation option or button is disposed in the same housing as the projection signal transmitter 52. The projection signal receiver 54, disposed in the body 10 and coupled to the information processing module 20, receives the one-time IP address display signal SA. The information processing module 20 controls the projection module 44 to project the IP address message onto the projection medium 3 according to the one-time IP address display signal SA. Alternatively, the display module 40 may include the screen 42 and the projection module 44 concurrently.

Thus, the users can obtain the IP address message and the status message of the electronic device, rapidly and conveniently, so that various settings may be made from the remote computer.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An electronic device, comprising:
a body;
an information processing module, disposed in the body, for processing information;
a network communication module disposed in the body, coupled to the information processing module and connected to a network, wherein an IP address is assigned to the network communication module after the network communication module is connected to the network; and
a display module, disposed on the body and coupled to the information processing module, for displaying continuously an IP address message representative of the IP address.

2. The electronic device according to claim 1, wherein the display module displays continuously the IP address message and a status message of the information processing module concurrently.

3. The electronic device according to claim 1, wherein the display module comprises a screen for displaying continuously the IP address message.

4. The electronic device according to claim 3, wherein the display module further comprises a projection module for projecting the IP address message onto a projection medium and displaying the IP address message on the projection medium.

5. The electronic device according to claim 4, wherein the projection module periodically projects the IP address message onto the projection medium.

6. The electronic device according to claim 4, further comprising:
a projection selecting module, coupled to the information processing module, for outputting a projection signal, wherein the information processing module controls the projection module to project the IP address message onto the projection medium according to the projection signal.

7. The electronic device according to claim 4, further comprising:
a projection signal transmitter for transmitting a projection signal; and
a projection signal receiver, disposed in the body and coupled to the information processing module, for receiving the projection signal, wherein the information processing module controls the projection module to project the IP address message onto the projection medium according to the projection signal.

8. The electronic device according to claim 1, further comprising:
a broadcast selecting module, coupled to the information processing module, for outputting a broadcast signal, wherein the information processing module controls the network communication module to output the IP address message to a remote device through the network according to the broadcast signal.

9. The electronic device according to claim 8, wherein the information processing module further controls the network communication module to output a status message of the information processing module to the remote device through the network according to the broadcast signal.

10. The electronic device according to claim 1, further comprising:
a broadcast signal transmitter for transmitting a broadcast signal; and
a broadcast signal receiver, disposed in the body and coupled to the information processing module, for receiving the broadcast signal, wherein the information processing module controls the network communication module to output the IP address message to a remote device through the network according to the broadcast signal.

11. An electronic device, comprising:
a body;
an information processing module, disposed in the body, for processing information;
a network communication module disposed in the body, coupled to the information processing module and connected to a network, wherein an IP address is assigned to the network communication module after the network communication module is connected to the network;
a display module, disposed on the body and coupled to the information processing module; and
an IP-address-display-selecting module, coupled to the information processing module, for transmitting a one-time IP address display signal to the information processing module, wherein the information processing module controls the display module to display an IP address message representative of the IP address for a predetermined period of time in response to the one-time IP address display signal.

12. The electronic device according to claim 11, wherein the display module displays the IP address message and a status message of the information processing module concurrently.

13. The electronic device according to claim 11, wherein the display module comprises a screen for displaying the IP address message.

14. The electronic device according to claim 11, wherein the display module comprises a projection module for projecting the IP address message onto a projection medium and displaying the IP address message on the projection medium.

15. The electronic device according to claim 14, wherein the IP-address-display-selecting module comprises:
a projection signal transmitter for transmitting the one-time IP address display signal; and
a projection signal receiver, disposed in the body and coupled to the information processing module, for receiving the one-time IP address display signal, wherein the information processing module controls the projection module to project the IP address message onto the projection medium according to the one-time IP address display signal.

16. The electronic device according to claim 11, further comprising:
a broadcast selecting module, coupled to the information processing module, for outputting a broadcast signal, wherein the information processing module controls the network communication module to output the IP address message to a remote device through the network according to the broadcast signal.

17. The electronic device according to claim 16, wherein the information processing module further controls the network communication module to output a status message of the information processing module to the remote device through the network according to the broadcast signal.

18. The electronic device according to claim 11, further comprising:
a broadcast signal transmitter for transmitting a broadcast signal; and
a broadcast signal receiver, disposed in the body and coupled to the information processing module, for receiving the broadcast signal, wherein the information processing module controls the network communication module to output the IP address message to a remote device through the network according to the broadcast signal.
